(19) United States
(12) Patent Application Publication
(10) Pub. No.: US 2023/0388542 A1
(43) Pub. Date: Nov. 30, 2023

(54) A METHOD AND APPARATUS FOR ADAPTING A VOLUMETRIC VIDEO TO CLIENT DEVICES

(71) Applicant: InterDigital CE Patent Holdings, SAS, Paris (FR)

(72) Inventors: Remi Houdaille, Cesson-Sevigne (FR); Charles Salmon-Legagneur, Rennes (FR); Charline Taibi, Chartres de Bretagne (FR); Serge Travert, Dinan (FR)

(21) Appl. No.: 18/030,815

(22) PCT Filed: Sep. 28, 2021
(86) PCT No.: PCT/EP2021/076558

§ 371 Date: Apr. 7, 2023

(30) Foreign Application Priority Data
Oct. 8, 2020 (EP) 20306174.2

(51) Int. Cl. H04N 19/597; G06T 17/00; G06T 7/70; H04N 13/279; H04N 13/351; H04N 19/119; H04N 19/172

(52) U.S. Cl. CPC H04N 19/597; G06T 17/00; G06T 7/70; H04N 13/279; H04N 13/351; H04N 19/119; H04N 19/172

(57) ABSTRACT

Methods and devices are disclosed to adapt a full-resolution 360° volumetric video content to the processing resources of different client devices. A 3D scene or a sequence of 3D scenes encoded as patch pictures, for example packed in atlas images is obtained; Patch pictures of the atlases are organized according to a sectorization of the three-dimensional space. Then, a request comprising information representative of a pose is received from a client device. Sectors of the sectorization are selected as a function of the pose information and the sectorization. The corresponding part is extracted and/or recomposed, encoded and transmitted to the client device.

### 1. TECHNICAL FIELD

The present principles generally relate to the domain of three-dimensional (3D) scene and volumetric video content. The present document is also understood in the context of the encoding, the formatting, the streaming and the decoding of data representative of the texture and the geometry of a 3D scene for a rendering of volumetric content on end-user devices such as mobile devices or Head-Mounted Displays (HMD). In particular, the present principles relate to a middle device or module for adapting a volumetric video content to different client-devices according to their processing resources.

### 2. BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

Volumetric video streaming to clients that use Head Mounted Displays (HMD) is a challenge for video delivery. As a transmission of the complete content in a desirable quality sacrifices a large part of available client and network resources, transmission of viewport-based content is more adapted to embedded devices. Moreover, the GPU and hardware decoding capabilities are often limited and fragment the market in a heterogeneity of devices. For example, the 2019 Snapdragon™ 855 supports HEVC decoding at 8K@60FPS (i.e. 8K resolution at 60 frames per second), while the older Snapdragon™ 835 (2017) embedded in the Oculus Quest HMD supports only 4K@60FPS.

Stereo immersive content (for instance encoded according to MPEG Immersive Video—MIV based on a 3DoF+ approach) at a satisfying video quality (e.g. 15 pixels per degree) represents an approximative bitrate of 5K@60FPS, meaning it cannot be decoded on older chips, but only on recent ones.

Therefore, there is a need for an intermediate actor in the cloud or in an edge device, to convert immersive content to a user-based content, that can be consumed by any rendering device even with low resources.

### 3. SUMMARY

The following presents a simplified summary of the present principles to provide a basic understanding of some aspects of the present principles. This summary is not an extensive overview of the present principles. It is not intended to identify key or critical elements of the present principles. The following summary merely presents some aspects of the present principles in a simplified form as a prelude to the more detailed description provided below.

In the context of a patch-based transmission of a volumetric video content, the present principles relate to a method comprising:
obtain patch pictures, a patch picture being a projection of a part of a 3D scene, wherein a patch is associated with a sector of a sectorization dividing a three-dimensional space in sectors;
receive a request comprising a pose information;
select sectors of the sectorization, the selected sectors comprising information for rendering the 3D scene based on the pose information;
generate a data stream comprising patch pictures associated with the selected sectors.

In an embodiment, the processor is configured to pack the patch pictures associated with the selected sectors in an adapted atlas image.

In a variant, the processor is configured to compose an adapted atlas image by slice-copying to the adapted atlas image, the selected sectors from a source atlas image.

The present principles also relate to a device comprising a memory associated with a processor configured to implement the method above.

The present principles also relate to a method comprising:
sending a request comprising a pose information;
receiving a data stream encoding patch pictures, a patch picture being a projection of a part of a 3D scene, wherein a patch is associated with a sector of a sectorization dividing a three-dimensional space in sectors, the encoded patch pictures being associated with sectors of the sectorization selected for comprising information for rendering the 3D scene based on the pose information; and
decoding the data stream.

In an embodiment, the request further comprises an indication of the computing resources of a device.

The present principles also relate to a data stream encoding patch pictures, a patch picture being a projection of a part of a 3D scene, wherein a patch is associated with a sector of a sectorization dividing a three-dimensional space in sectors, the encoded patch pictures being associated with sectors of the sectorization selected for comprising information for rendering the 3D scene based on a pose information

### 4. BRIEF DESCRIPTION OF DRAWINGS

The present disclosure will be better understood, and other specific features and advantages will emerge upon reading the following description, the description making reference to the annexed drawings wherein:

FIG. 1 shows a three-dimension (3D) model of an object and points of a point cloud corresponding to the 3D model, according to a non-limiting embodiment of the present principles;

FIG. 2 shows a non-limitative example of a system configured for the encoding, transmission and decoding of data representative of a sequence of 3D scenes, according to a non-limiting embodiment of the present principles;

FIG. 3 shows an example architecture of a device which may be configured to implement a method described in relation with FIG. 7, according to a non-limiting embodiment of the present principles;

FIG. 4 shows an example of an embodiment of the syntax of a stream when the data are transmitted over a packet-based transmission protocol, according to a non-limiting embodiment of the present principles;

FIG. 5 illustrates the patch atlas approach with an example of 4 projection centers, according to a non-limiting embodiment of the present principles;

FIG. 6 illustrates a selection and a slice copy of sectors of an adaptable atlas to generate an adapted atlas, according to a non-limiting embodiment of the present principles;

FIG. 7 illustrates a method for converting a full-resolution 360° sectorized atlas sequence into a user-based atlas sequence, according to a non-limiting embodiment of the present principles;

FIG. 8 illustrates an embodiment of a sectorization of the 3D space of the 3D scene, according to a non-limiting embodiment of the present principles;

FIG. 9 illustrates a first layout of a sectorized atlas according to the present principles;

FIG. 10 shows a second layout of a sectorized atlas according to the present principles.

### 5. DETAILED DESCRIPTION OF EMBODIMENTS

The present principles will be described more fully hereinafter with reference to the accompanying figures, in which examples of the present principles are shown. The present principles may, however, be embodied in many alternate forms and should not be construed as limited to the examples set forth herein. Accordingly, while the present principles are susceptible to various modifications and alternative forms, specific examples thereof are shown by way of examples in the drawings and will herein be described in detail. It should be understood, however, that there is no intent to limit the present principles to the particular forms disclosed, but on the contrary, the disclosure is to cover all modifications, equivalents, and alternatives falling within the spirit and scope of the present principles as defined by the claims.

The terminology used herein is for the purpose of describing particular examples only and is not intended to be limiting of the present principles. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as“/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present principles.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present principles. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims. While not explicitly described, the present examples and variants may be employed in any combination or sub-combination.

Volumetric content may be transmitted as 2D video (for instance, HEVC encoded atlases (color texture+depth)), resulting from the projection (e.g. equirectangular (ERP) or Cube-map projection) of clusters of 3D points into multiple 2D views. This allows to generate parallax effects when rendering video on the end terminal. In such an embodiment, a patch is a picture resulting from the projection of a cluster of 3D points onto this picture. When encoding a volumetric scene, projected patches are packed together to form the color and depth atlases; In some embodiments, a central patch comprises the part of the scene visible from a main central viewpoint and peripheral patches embed the complementary parallax information visible from peripheral viewpoints comprised in a viewing area of the 3D space.

The consumption of 360° atlases may be problematic on embedded devices. To ensure a good visual quality, for example, at a resolution of 15 pixels per degree, atlases comprising more than 14M pixels (5.3K×2.65K) are required. This is beyond the HEVC decoding capacities of a low-end client device. Therefore, there is a need to lower the decoding processing requirements of the device.

A possible approach includes generating in the cloud or in an edge entity a collection of smaller viewport-based atlases (below 4K@60FPS) and to stream them to the client device. Another approach includes splitting and encoding an ERP content per radial orientations in 3D space. This technique increases the number of contents/tiles stored on the server (e.g. around 70 tiles for a 360° content). The multiple orientation encoding induces a lot of content redundancy on server and increases computation time on the ingress side.

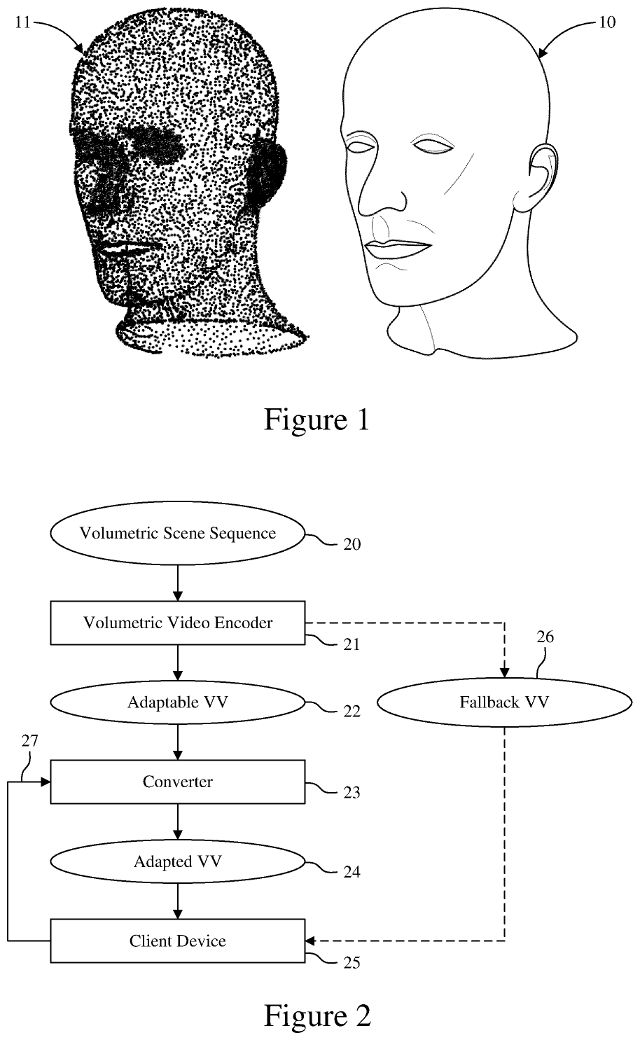

FIG. 1 shows a three-dimension (3D) model 10 of an object and points of a point cloud 11 corresponding to 3D model 10. 3D model 10 and the point cloud 11 may for example correspond to a possible 3D representation of an object of the 3D scene comprising other objects. Model 10 may be a 3D mesh representation and points of point cloud 11 may be the vertices of the mesh. Points of point cloud 11 may also be points spread on the surface of faces of the mesh. Model 10 may also be represented as a splatted version of point cloud 11, the surface of model 10 being created by splatting the points of the point cloud 11. Model 10 may be represented by different representations such as voxels or splines. FIG. 1 illustrates the facts that a point cloud may be defined with a surface representation of a 3D object and that a surface representation of a 3D object may be generated from a point of cloud. As used herein, projecting points of a 3D object (by extension points of a 3D scene) onto an image is equivalent to projecting any representation of this 3D object, for example a point cloud, a mesh, a spline model or a voxel model.

A point cloud may be represented in memory, for instance, as a vector-based structure, wherein each point has its own coordinates in the frame of reference of a viewpoint (e.g. three-dimensional coordinates XYZ, or a solid angle and a distance (also called depth) from/to the viewpoint) and one or more attributes, also called components. An example of component is the color component that may be expressed in various color spaces, for example RGB (Red, Green and Blue) or YUV (Y being the luma component and UV two chrominance components). The point cloud is a representation of a 3D scene comprising objects. The 3D scene may be seen from a given viewpoint or a range of viewpoints. The point cloud may be obtained by many ways, e.g.:
from a capture of a real object shot by a rig of cameras, optionally complemented by depth active sensing device;
from a capture of a virtual/synthetic object shot by a rig of virtual cameras in a modelling tool;
from a mix of both real and virtual objects.

FIG. 5 illustrates the patch atlas approach with an example of 4 projection centers. 3D scene 50 comprises a character. For instance, center of projection 51 is a perspective camera and camera 53 is an orthographic camera. Cameras may also be omnidirectional cameras with, for instance a spherical mapping (e.g. Equi-Rectangular mapping) or a cube mapping. The 3D points of the 3D scene are projected onto the 2D planes associated with virtual cameras located at the projection centers, according to a projection operation described in projection data of metadata. In the example of FIG. 5, projection 51 of the points captured by a camera is mapped onto patch 52 according to a perspective mapping and projection of the points captured by camera 53 is mapped onto patch 54 according to an orthographic mapping.

The clustering of the projected pixels yields a multiplicity of 2D patches, which are packed in a rectangular atlas 55. The organization of patches within the atlas defines the atlas layout. In an embodiment, two atlases with identical layout are used: one for texture (i.e. color) information and one for depth information. Two patches captured by a single camera or by two distinct cameras may comprise information representative of the same part of the 3D scene, like, for instance patches 54 and 56.

The packing operation produces a patch data for each generated patch. A patch data comprises a reference to a projection data (e.g. an index in a table of projection data or a pointer (i.e. address in memory or in a data stream) to a projection data) and information describing the location and the size of the patch within the atlas (e.g. top left corner coordinates, size and width in pixels). Patch data items are added to metadata to be encapsulated in the data stream in association with the compressed data of the one or two atlases.

The layout of an atlas is the way patches are organized on the image plane of the atlas. In some embodiments, an atlas comprises a first part comprising the texture information of the points of the 3D scene that are visible from a given viewpoint (e.g. chosen to be the most central in the viewing area) and one or more second parts comprising patches obtained from other viewpoints. The first part may be considered as “a central patch” and patches of the second parts may be called “peripheral patches” as they are used to retrieved parallax information visible when the user is not located at the given viewpoint.

In such embodiments, after having decoded the color and depth atlases, a rendering device carries out the reverse operations for a 3D rendering. The immersive rendering device de-projects each pixel of each patch of the atlases to rebuild a 3D point, and re-projects the 3D point into the viewport of the current pyramid of vision of the user.

This implies two types of operations on the rendering device:
memory lookups to fetch the color and depth values of each pixel in the atlases (operations capped by the GPU memory bandwidth); and
computing to de-project/re-project each point (operations well adapted to massively parallel GPU architecture).

In a typical implementation, the rendering engine pipelines the processing of vertex/fragment shaders, that are executed for each pixel of the atlases, but triggers several memory lookups equals to the size of the atlases. For example, for a 4K HMD supporting up to 15 pixels per degree, an atlas is composed of more than 17M pixels (5.3K×3.3K).

This approach has a noticeable drawback: the atlases contain patches for any direction) (360°×180°, while only the patches belonging to the end-user device Field of View, FOV, (typically a 90°×90° FOV for a HMD, i.e. one eight of the 3D space) are effectively visible in the current viewport; then, the rendering engine may read up to 8 times more pixels than necessary.

According to the present principles, for fast rendering on low-end user devices, the number of memory look-ups and de-projections is decreased by reading only the subset of patches in the atlas that are visible in the current user's field of view; i.e. selecting only the patches appearing in the user view direction.

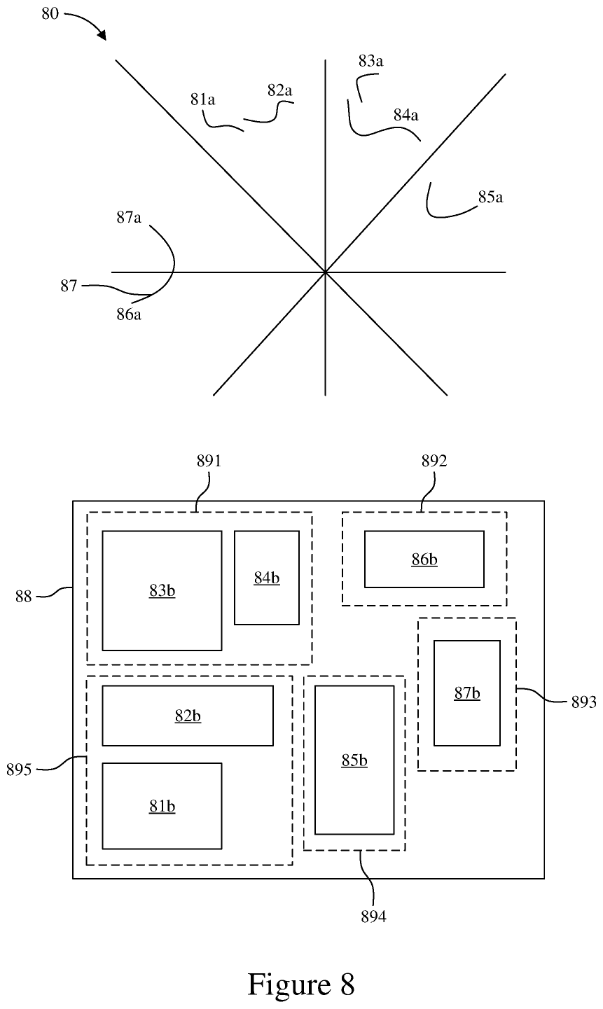

FIG. 8 illustrates an embodiment of a sectorization of the 3D space of the 3D scene. In this example, a spherical projection and mapping, like Equi-Rectangular Projection (ERP), is selected to project points of the 3D scene onto patches of an atlas. A sector is a disjointed part (i.e. non-overlapping another sector) of the 3D space of the 3D scene. In this particular embodiment, a sector is defined by a solid angle; that is a (theta (i.e. the horizontal rotation angle), phi (i.e. the vertical rotation angle)) range pointing from a reference point (e.g. the center point of view of the 3DoF+ viewing box) of the 3D space, where theta and phi are the polar coordinates.

In FIG. 8, space 80 of the scene is divided in eight sectors of the same angular size. Sectors may have different angular sizes and do not necessarily cover the entire space of the scene. The number of sectors may to optimize the encoding and the decoding according to the principles detailed herein. Space 80 comprises several objects or parts of objects 81a to 87a. Points of the scene are projected on patches as illustrated in FIG. 5. Parts of objects to be projected on patches are selected in a way that ensures that pixels of a patch are a projection of points of a same sector. In the example of FIG. 8, object 87 has points belonging to two sectors. Then, points of object 87 are split in two parts 86a and 87a, so, when projected, points of part 86a and points of part 87a are encoded in two different patches. Patches associated with a same sector are packed in a same region of the atlas. For instance, a region is a rectangular area of the atlas image, a region may pack several patches. In a variant a region may have a different shape, for example, a region may be delimited by an ellipse or by a generic polygon. Patches of a same region are projections of points of a same sector. In the example of FIG. 8, five of the eight sectors of the space of the scene comprise points. According to the present principles, atlas image 88 representative of the scene comprises five regions 891 to 895. A region packs patches that are projection of a points belonging to a same sector. For instance, in FIG. 8, region 891 comprises patches 83b and 84b corresponding to groups of points 83a and 84a that belong to a same first sector. Groups of points 86a and 87a, even if parts of a same object 87, produce two patches 86b and 87b as they belong to two separate sectors. Patch 86b is packed in a region 892 while patch 87b is packed in a different region 893. Patch 85b is packed in a region 894 because corresponding points of the scene belong to a second sector and patches 81b and 82b respectively corresponding to groups of points 81a and 82a are packed in a region 895 as being included in a same sector.

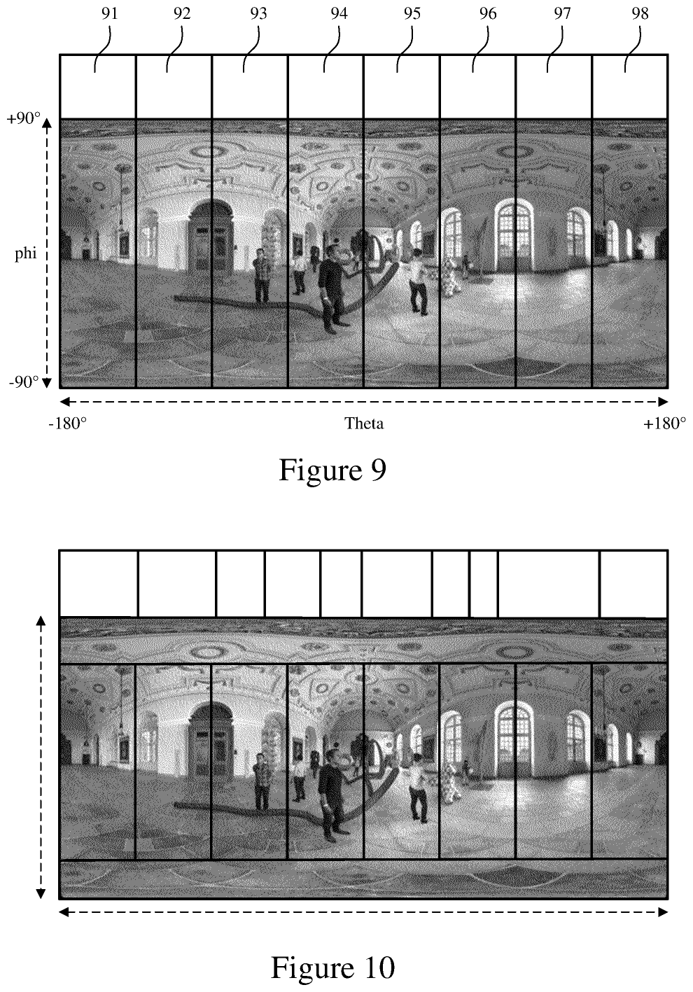

FIG. 9 illustrates a first layout of a sectorized atlas according to the present principles. A central patch is split into n regions (8 in the example of FIG. 9), each region being associated with one of the n sectors of the sectorization. In this embodiment, each region of the central patch (herein called central region) comprises information corresponding to the same angular amplitude and so the same number of pixels when projected onto an ERP image. Peripheral patches are also sorted in regions (herein called peripheral regions) associated with a sector of same angular amplitude (8 in the example of FIG. 9), and then packed into peripheral regions 91 to 98. Unlike in the central patch, the quantity of data by peripheral region is not the same because it depends on the quantity of parallax information for a given sector. In FIG. 9, the peripheral regions may have different sizes. In a variant, peripheral regions 91 to 98 have the same size. Unused pixels may be filled with a determined value, for instance 0 or 255 for depth atlases and white, grey or black for color atlases.

| Regions | Sector definition | Atlas Area |
|---|---|---|
| 8 regions R_{c}_pan_{—}ᵢ | For i = 0 to 7 | ⅛ of central patch |
| for central patch | theta [i*45°, (i + 1)*45°] | |
| | and phi [−90°, +90°] | |
| 8 regions Rₚ_pan_{—}ᵢ | For i = 0 to 7 | Around ⅛ of all |
| for peripheral patches | Theta [i*45°, (i + 1*45°)] | peripheral patches |
| | and phi [−90°, +90°] | |

In a 3DoF+ rendering device, a processor manages a virtual camera located in the 3DoF+ viewing zone. The virtual camera defines the point of view and the field of view of the user. The processor generates a viewport image corresponding to this field of view. At any time, depending on the user viewport direction (thetaᵤₛₑᵣ, phiᵤₛₑᵣ), the renderer selects at least one sector, for instance 3 or 4 sectors, and, then accesses and processes the same number of central regions and peripheral regions. In the example of FIGS. 8 to 10, only 37.5% (3/8 sectors) or 50% (4/8 sectors) of the patches are processed. The number of selected sectors may be dynamically adapted by the renderer depending on its CPU and/or GPU capabilities. The number of selected sectors by the renderer at any time covers at least the field of view. Additional sectors may be selected to enhance reliability to render peripheral patches at the borders of the current field of view (FOV) for lateral and/or rotation movements of the user. The number of selected sectors is determined to cover the current user field of view (FOV) with appropriate overprovisioning to respond positively to the motion to photon latency issue but being small enough to optimize the rendering (that is the number of regions of the atlas that the decoder accesses to generate the viewport image). An atlas layout like the one illustrated in FIG. 10 is adapted for a generic “gaze path”. The number of selected (and so accessed by the decoder) sectors may correspond to the entire atlas when the user is looking toward a pole. The rate of the accessed regions of the atlas is then 100%.

FIG. 10 shows a second layout of a sectorized atlas according to the present principles. In this example, wherein the selected projection and mapping is the ERP, the central patch is divided in 10 regions: eight for a large equatorial zone as in the example of FIG. 9 and two for the poles. Ten regions of the atlas are then dedicated to peripheral patches of the ten sectors.

| Regions | Sector definition | Atlas Area |
|---|---|---|
| 8 panoramic Regions R_{c}_pan_{—}ᵢ | For i = 0 to 7 | 1/16 of central |
| for central patch | theta [i*45°, (i + 1)*45°] | patch |
| | and phi [−(90° + phi_{fov}/2), +(90° − | |
| | phi_{fov}/2)] | |
| 2 pole Regions R_{c}_pol_{—}ᵢ | theta [−180°, +180°] | ¼ of central |
| for central patch | and phi [+(90° − phi_{fov}/2), +90°] | patch |
| | theta [−180°, +180°] | |
| | and phi [−(90° + phi_{fov}/2), −90°] | |
| 8 panoramic Regions Rₚ_pan_{—}ᵢ | For i = 0 to 7 | Around 1/16 of |
| for peripheral patches | theta [i*45°, (i + 1)*45°] | peripheral patches |
| | and phi [−(90° + phi_{fov}/2), +(90° − | |
| | phi_{fov}/2)] | |
| 2 pole Regions Rₚ_pol_{—}ᵢ | theta [−180°, +180°] | Around ¼ of |
| for peripheral patches | and phi [+(90° − phi_{fov}/2), +90°] | peripheral patches |
| | theta [−180°, +180°] | |
| | and phi [−(90° + phi_{fov}/2), −90°] | |

This second layout differs from the first layout illustrated in FIG. 9 in terms of the number of selected sectors according the user's gaze direction and gaze path. Indeed, at the rendering side, regions of the atlas corresponding to the poles will be accessed and de-projected only when the user is looking above or below a given angle (depending on the size of pole regions). In the layout of FIG. 9, when the user is looking at a pole, every central patch (that is every region) has to be accessed to get the necessary information to generate the view port image. In the layout of Figure only one pole region and a number of panoramic regions (for example four, depending on the width of the field of view) have to be accessed to generate the viewport image. Thus, in every case, fewer regions have to be accessed. Such a sectorization of the space may be preferred when information about the expected gaze path of the user is known at the encoder: for example, when the field of view of the renderer is the same for every target device, when regions of interest of the volumetric content are indicated by an operator and/or automatically detected and/or when the user's gaze path routines are known at the encoder. In the example sectorization illustrated in FIG. 10, different amplitudes for angles theta and phi may be determined according to such information.

FIG. 2 shows a non-limitative example of a system configured for the encoding, transmission and decoding of data representative of a 3D scene or a sequence of 3D scenes. The encoding format that may be, for example and at the same time, compatible for 3DoF, 3DoF+ and 6DoF decoding.

A sequence 20 of a volumetric scene (i.e. 3D scenes as depicted in relation to FIG. 1) is obtained by a volumetric video encoder 21. Encoder 21 generates an adaptable immersive content, for example an adaptable volumetric video. According to the present principles, an adaptable volumetric video (VV) comprises a sequence of patch atlases as described in relation to FIG. 5, enriched with dedicated metadata to enable quick conversions by converter 23. In some embodiments, encoder 21 builds atlases that have pre-sectorized patches, leveraging the mechanisms described in relation to FIGS. 8 to 10. In another embodiment, encoder 21 adds visibility metadata to the content, providing the list of visible patches per orientation and per video frame. These visibility metadata may be generated upstream, in a pre-cloud-rendering step.

Generated adaptable volumetric video 22 is transmitted to converter 23 that performs a user-based conversion of adaptable VV 22 in a cloud network or in an edge device. From one converter 23, the system is able to serve either high-end client devices (i.e. the content from encoder 21 is transmitted without modification), either a low-end client devices (i.e. a device with low resources, for example HEVC decoding limited at 4K@60FPS or texture scanning limited by memory bandwidth), for which the converter dynamically generates and transmits a viewport-based immersive content. Converter 23 receives a request 27 comprising a pose (i.e. a view location and orientation) and a period of time from a client device 25 and generates an adapted VV 24 (i.e. a sequence of adapted atlases) from adaptable volumetric video 22 based on this request. Converter 23 may generate adapted atlases for different client devices 25.

The client device 25 is equipped to track the pose of a virtual camera within the rendering space. For example, the user may wear a HMD. The client device tracks the pose of the HMD by using an embedded Inertial Measurement Unit (IMU) and/or external cameras filming the user. Client device 25 sends requests comprising the current pose and/or a predicted pose and, in an embodiment, the period of time of the content to be rendered to converter 23. Converter 23 build and transmit an adapted atlas to client device 25. Client device 25 decodes the adapted atlases and render the viewport image as a function of the current pose of the virtual camera.

In every embodiment, encoder 21 also may generate a fallback volumetric video 26 that is transmitted to client device 25. For instance, the fallback volumetric video 26 is a low-resolution video, for example obtained by downscaling pixels of adaptable volumetric video 22 by a given factor (e.g. a factor of 2 or of 4). The fall back volumetric video may be used by the client device to generate the viewport image in case information is missing in the received adapted atlas (e.g. in case of very fast motion of the virtual camera).

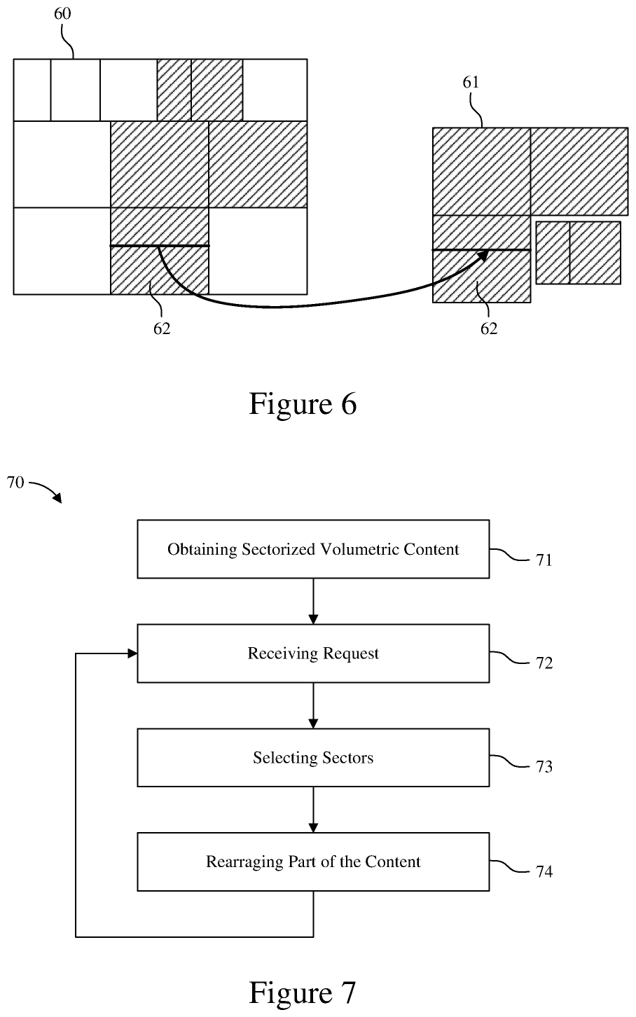

In a first embodiment, encoder 21 generates two volumetric videos in two resolutions, one adaptable volumetric video content in full resolution intended to be transformed by the converter, and one in low resolution for fallback intended to be consumed by the client device (i.e. the converter does not make any modification on it). The fallback volumetric video may conform to a standard, for example MIV content (e.g. FULL 360°, unsectorized atlas, HEVC encoding, low resolution). Regarding the full resolution atlas, the encoder adds in the metadata a sectorization information (e.g. a sector_id parameter) associated with each patch, and adds a sectorization layout within the encoded atlas, as illustrated in FIGS. 9, 10 and 6. For instance, a full resolution may be the maximum resolution supported by a 4K HMD for 360° and equals 15 pixels per degree in 2019. For instance, a low resolution may be deduced from the full resolution by downscaling pixels (e.g. by a factor of two or four).

In a variant of this first embodiment, the sectorization information is encoded at the encoding stage. Indeed, the extra cost of sectorizing patches is negligible at this stage of the content generation, it is merely transparent in the generation workflow, and it makes the conversion in the converter device very simple and very fast. In an implementation, encoder 21 encodes the full resolution atlases (color+depth) in a lossless format (for example HEVC lossless), because it is intended to be decoded by the converter and re-encoded again. Successive encoding and decoding steps would deteriorate the accuracy of the depth information, which is critical and sensitive for volumetric content to rebuild the geometry of the point cloud. In another implementation, another type of encoding may be used. In another variant of the first embodiment, the volumetric content is sectorized after encoding. This variant requires a GPU to compute the sectorization information (for de-projecting and re-projecting every atlas pixel to the Cartesian space of a reference viewpoint).

According to the present principles, the converter can be a lightweight processing unit, that rearranges the content of received atlas, by selecting the patches to be kept according to pose and time period criteria, and pack them into an output atlas adapted for a client device. This operation is not CPU intensive and does not require any GPU. It is only capped by the available memory bandwidth. Two types of infrastructure may be designed depending on the consumption model:
For an OTT on demand service, for each user, a MIV converter can be run in an edge or a cloud instance. It necessitates, for one user, one CPU, an HEVC decoding and reencoding chip, and 1 to 3 GB/s of memory bandwidth.
For a live event service, (e.g. broadcast service), one dedicated server architecture can be allocated for all users.

In the first embodiment, the converter sequentially performs the following actions:
It receives the adaptable atlas from the encoder and reads the patches metadata, the sector_id information.
It decodes the atlases to memory in a clear raw format (e.g. YUV420 planar format, or NV12 YUV420 semi-planar, or RGB).
It determines, for one user pose (position+orientation thetaᵤₛₑᵣ, phiᵤₛₑᵣ) and given period of time (e.g. the requested segment duration), the list of Nᵤₛₑᵣ sectors to be selected to cover the over-provisioned user viewport (for example thetaᵤₛₑᵣ+/−90°, phiᵤₛₑᵣ+/−90°.). and for each selected sector:
   it performs a slice-copy of the selected area covered by the sector to the user-based atlas.
   it accordingly updates the packing information (i.e. position of all patches belonging to selected sectors in the atlas) in the metadata of the output adapted content.
   it encodes the output color and depth atlases for example by using HEVC Main 10 profile.
   It transmits the output user-based atlases to the end user device, as well as the corresponding fallback atlases.

FIG. 6 illustrates a selection and a slice copy of sectors of an adaptable atlas 60 to generate an adapted atlas 61. Adaptable atlas 60 has a sectorized layout that may correspond to a cube mapping projection. In this example, five sectors are selected as containing information necessary to generate viewport images for poses around a given pose provided by a client device for a time period of the playing of the volumetric video. Each sector, like selected sector 62 comprises at least one patch as illustrated in relation to FIG. 8. The selected sectors are slice-copied, in their integrality, into the adapted atlas 61.

The slice-copy of a sector 62 is performed on a decoded raw format of adaptable atlas 61 (e.g. YUV420 planar, YUV420 semi-planar, or RGB). The same copy mechanism is performed for each plane of the atlas image (e.g. Y, U, V planes for YUV420 planar, Y and interleaved UV planes for YUV 420 semi-planar, like for NV12 frames decoded by NVidia NVDEC, and RGB single plane). The slice-copy applies on the bounding area of sector 62 of size W_{sector}×H_{sector}, even if this area is sparse and not fully filled with patches. The slice-copy of sector 62 consists in a memory copy between decoded atlases in raw format and considers the image strides of the input and output planes. Each horizontal line (i.e. a slice line) of sector 62 is copied individually. So, a sector 62 of height H_{sector} requires H_{sector} copies of slice lines. Assuming a sector 62 in the Y plane of size (Wₐₜₗₐₛ,Hₐₜₗₐₛ) of input atlas is at memory address @O1 in the input bitstream, and has to be copied at memory address @O2 of the output bitstream, each line I of length in pixels W_{sector}, starting at source address O₁+I×Wₐₜₗₐₛ is copied to address O2+I×Wᵤₛₑᵣ. The length l in bytes of the slice line depends on the number of bits per pixel of the texture (e.g. l=W_{sector} bytes for YUV 420 8 bit, and the double for YUV 420 10 bit). So, the total of bytes to be copied for the sector is 3/2×W_{sector}×H_{sector} (resp. 3×W_{sector}×H_{sector}) for YUV 420 8 bits (resp. 10 bits). The slice-copy of a sector copies all patches of a sector in a single operation. By this way, the read and write operations in cache memory are also optimized. The maximum number of sectors supported by an end-user device depends on its capabilities and may be indicated in the user request, in addition to the predicted pose and given period of time (e.g. segmentId).

In the first embodiment of the present principles, client device 25 has a low-end GPU and an HEVC HW decoder chip supporting at least 4K@60FPS. This is required to be able to decipher the color and depth user-based atlas at 2.5 k@30FPS×2, plus the fallback atlases 1 k@30FPS×2. It has also a tracking device that it uses to predict a future orientation and position of the virtual cameras for the next segment of time (e.g. next GOP duration, for example next 250 ms if GOP duration is 250 ms). In advance, in prediction to the next Group Of Pictures (GOP), client device sends a content request to converter 23, specifying in a parameter the predicted pose. The converter sends back in response a user-based atlas included in a GOP segment, as well as a fallback segment. The syntax of the two atlases is not different from that of a reference MIV atlas. They are both HEVC decoded on reception.

In the current GOP interval of time, at each device display refresh (e.g. at 70 Hz to 90 Hz for an HMD) two cases may occur:
The current pose is fully included in the predicted Field Of View (FOV): in this case the decoded user-based atlas is rendered, e.g. its content is de-projected and re-projected onto the viewport image for the current pose.
The current pose is not fully included (part of the FOV has no corresponding data in the user-based atlas): in this case the client device renders the content by combining data from low resolution and high resolution atlases. For example, two successive renderings are done to draw the viewport, the rendering of the low resolution full 360° fallback atlas as a background, followed by the rendering of the user-based atlas as a foreground.

A second embodiment is designed to improve the scalability of the converter by skipping the HEVC decoding/reencoding process, that is, by retransmitting the selected sectors as encoded. In this second embodiment, the client device is able to independently decode each received sector. Encoder 21 sectorizes the full resolution volumetric content as in the first embodiment. Then, it encodes each sector independently. In a first variant, the encoder encodes each sector individually into an HEVC elementary stream. There are different techniques to transport such streams, one way is to dedicate one transport track for each HEVC elementary stream. This approach keeps access to individual sectors simple for the converter. Signaling is included in metadata to describe the organization of the tracks. It can be for example the same bitstream_param(a) descriptor as the one used by the converter below. In a second variant the encoder uses the HEVC tiling technique, with motion-constrained tiles predictions. In this variant, the encoder encodes each sector in an HEVC tile. All tiles—i.e. all sectors—are packaged together into an HEVC stream. Some signaling must be included in metadata to describe the mapping between the tiles and the sectors. The low-resolution atlas is generated like in the first embodiment. In a variant of the second embodiment, sectors have the same size. Indeed, when using separate HEVC streams, each change in the dimensions of the images requires a specific decoder initialization by the client device, which can be time-consuming. When using HEVC tiling, rectangular tiles are packed into a larger rectangle, so uniform sizes allow better packing.

In the second embodiment, the converter determines, for one user pose and given period of time, the list of Nᵤₛₑᵣ sectors to be selected to cover the over-provisioned user viewport. The converter selects from the adaptable data stream each HEVC elementary stream or HEVC tile associated with the Nᵤₛₑᵣ sectors currently selected. The converter concatenates them into a user-based HEVC bitstream. In a variant the converter generates a data stream by rearranging the subset of tiles associated with the Nᵤₛₑᵣ sectors (instead of slice-copies at raw level). It adds signaling in metadata to specify the list of sectors transmitted, for each sector their sector_id, the 2D packing position in the original atlas (optional), and their position and length in the HEVC bitstream or the tiling arrangement. In the variant where sectors are encoded in separate streams, the streams may be concatenated after sorting them by picture sizes. This allows the client device to trigger a serialized decoding without waiting for the complete reception of all sectors.

The organization of the tracks may be signaled in the metadata, for instance, according to the following syntax:

| | |
|---|---|
| bitstream_param(a) { | |
| num_sectors_minus1 | Uint(8) |
| use_hevc_tiling | Bool(1) |
| for ( i = 0; i <= num_sectors_minus1; i++ ) { | |
| Sector_id | Uint(8) |
| sector_pos_in_atlas_x[a][i] | Uint(32) |
| sector_pos_in_atlas_y[a][i] | Uint(32) |
| sector_width_in_atlas_x[a][i] | Uint(32) |
| sector_height_in_atlas_y[a][i] | Uint(32) |
| if (use_hevc_tiling) { | |
| tile_id | Uint(16) |
| } | |
| else { | |
| Bitstream_offset[a][i] | Uint(32) |
| Bitstream_length[a][i] | Uint(32) |
| } | |
| } | |

When HEVC tiling is not used, at initialization time, the client device may initialize N_{decoders} HEVC decoders for GOP frames, N_{decoders} being the number of different dimensions for all sectors of the user-based adapted atlas and low-resolution atlas. This information may be provided in a configuration file, or may be embedded in the device or may be transmitted by the converter. An example of configuration is to initialize three to five decoders:
One decoder of size Wl_{owres_atlas},H_{lowres_atlas} for the full low resolution fallback atlas,
One decoder of size W_{central_patch}×H_{central_patch} for all sectors Rc_pan_i of the main central patch,
One decoder of size W_{peripheral_patch}*H_{peripheral_patch} for all sectors Rp_pan_i of peripheral patches,
(if the atlas layout includes poles) two decoders of size W_{central_pole_patch}×H_{central_pole_patch}, W_{peripheral_pole_patch}×H_{peripheral_pole_patch}.

A variant consists in using a single HEVC decoder and to initialize it and release it before/after decoding of each sector, as soon as the sector size changes. In one embodiment, the list of sectors to decode may be sorted by their sector dimension before being sent to decoders, to minimize the number of decoder initializations and changes.

At a reception of a user-based HEVC bitstream, the client device starts by reading its metadata. From the parsing of bitstream_param(a) information, it deduces the list of sectors, their atlas packing position and their bitstream position. It extracts from the bitstream each individual bitstream of a sector and serializes their HEVC decoding to the correct HEVC decoder initialized for the dimension of this sector. The client device sorts the individual bitstreams by sector dimension before submitting to the decoder. In a variant, the converter transmits sectors grouped by their picture size. If HEVC tiling is used, a single decoder is initialized, which is capable of decoding all tiles maybe in parallel. The list of all decoded sectors is used for rendering, in place of a full atlas as in previous embodiments. Here are two examples of possible implementation:
The original atlas frame is reconstituted by recopying decoded sectors at their original position, using the sector packing information in bitstream_param(a).
The rendering shaders are modified to take as input not a single texture for the atlas frame, but a list of 2D textures corresponding to each decoded sector. A sector_id attribute is also transmitted associated with each patch in the metadata in atlas_param(a).

A third embodiment of the present principles addresses the case where encoder 21 is not configured to generate sectorized atlases. In the third embodiment, additional information is produced by a visibility metadata builder precomputing a visibility map for later patches filtering.

In this embodiment:
The MIV encoder outputs a reference non-sectorized full 360° volumetric content, encoded in a lossless format.
A third actor (i.e. the visibility metadata builder), which can be part of the encoder or implemented in a separate device (e.g. a cloud computing grid) computes the visibility metadata and transmits it to the converter.

The visibility metadata comprise a two-dimensional association table, that gives, for a set of orientations Oᵢ {thetaᵢ,phiᵢ} and for each atlas frame at time tⱼ, the exhaustive list L_{i,j} of patch identifiers for patches that are visible in an over-provisioned FOV centered around this orientation. A patch is visible when a subset of pixels of the patch, at any given time in a GOP time interval, becomes visible in the considered FOV, and that their number is greater than a threshold value or than a percentage of the total pixels of the patch. Because each patch may be contained in different views and different camera Cartesian spaces, computing the list of visible patches L_{i,j} for one orientation Oᵢ involves decoding/deprojections/reprojections and mathematical operations for each pixel of the atlas, and for each frame. The numerous possibilities of user orientations in the 360° content received by the converter is approximated by a finite set of orientations {Oᵢ}.

As in the first embodiment, the converter receives a full 360° atlas from the encoder, decodes it into a decoded domain (example: YUV) and generates a smaller user-based atlas for a predicted user pose. In the third embodiment, the filtering of patches is performed at the patch level instead of at the sector level. The converter reads the visibility metadata received from the encoder. For a given user orientation Oᵤₛₑᵣ (thetaᵤₛₑᵣ,phiᵤₛₑᵣ) and a given period of time:
The converter selects in the set of orientations {Oᵢ} described in visibility metadata, where Oᵢ=(thetaᵢ, phiᵢ), the closest orientation to the current user orientation.
It reads in visibility metadata the list of visible patches pre-computed for orientation Oᵢ in the given period of time. That is, it computes the union list L=union of patches in lists L_{i,1} to L_{i,tnb_frames}.
It makes slice-copies in the decoded domain (e.g. YUV) of all patches selected in the list L to the destination user atlas.
The following operations are identical to those of the first embodiment.

In a use case in which all users consume a live-generated volumetric content at the same moment, only the user orientation, and thus the user-based volumetric content differs from one client device to another one. According to the present principle, for example in the second embodiment, it is possible to avoid the storage overhead induced by producing and storing all sectorized combinations. Instead, only the adaptable content is stored. Then real-time conversion is performed on the fly to serve the plurality of client devices. A possible implementation of the converter can be supported by a single edge or cloud device. The edge device generates chunks of content for one GOP duration, for all atlases in parallel.

For example: a dual socket server with 40 cores:
The encoder generates a single sectorized adaptable volumetric content.
In the edge server:
   16 to 32 cores in parallel generate 16 to 32 user based MIV content chunks (one segment of 1 GOP duration, only valid for an interval of time) and push the result to caches (hard disk cache or memory caches. 1 chunk=2K×1K atlases×2 (color+depth)×6 for a GOP of 200 ms=24M. All the 32 chunks corresponding to one segment duration can be easily stored together in a memory bank).
   Each core must HEVC encode in real time the two 2K (e.g. equivalent to a 1080p) user-based atlases at 30FPS which is easily reachable in hardware and even with pure software codecs (particularly for intel CPUs that add support to AVX512 instructions set). It must also be noted that intel 10th generation processor comet lake now supports HEVC 10-bit HW decode/encode.
   One monitor core monitors the user requests and, depending on the user orientation, pick the right user-based generated chunk for a given time (t) in one of the caches.

Preliminary studies have shown that a core implementing the present principles, for memory slice-copies of the ingress content in a decompressed format to the user-based format would require between a 1 GB/s and 3 GB/s memory bandwidth per core, depending on the pixel per degree resolution, and the number of bits per pixels used for textures (YUV420 10 bits versus 8 bits for HEVC Main10 profile).

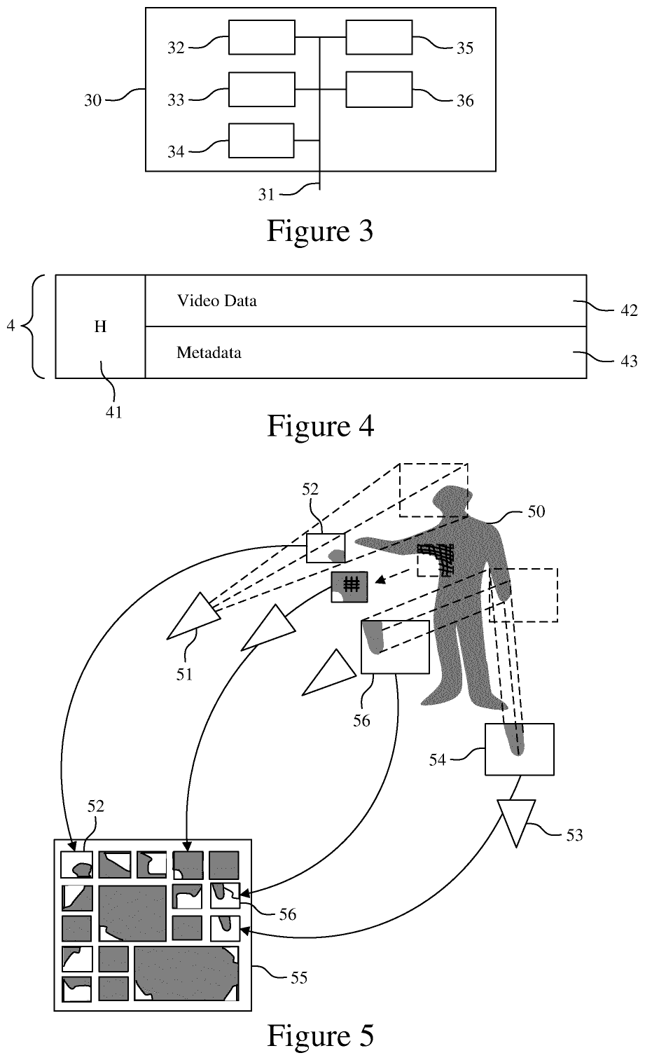

FIG. 3 shows an example architecture of a device 30 which may be configured to implement a method described in relation with FIG. 7. Encoder 21 and/or converter 23 and/or decoder 25 of FIG. 2 may implement this architecture. Alternatively, each circuit of encoder 21 and/or converter 23 and/or client device 25 may be a device according to the architecture of FIG. 3, linked together, for instance, via their bus 31 and/or via I/O interface 36.

Device 30 comprises following elements that are linked together by a data and address bus 31:
a microprocessor 32 (or CPU), which is, for example, a DSP (or Digital Signal Processor);
a ROM (or Read Only Memory) 33;
a RAM (or Random Access Memory) 34;
a storage interface 35;
an I/O interface 36 for reception of data to transmit, from an application; and
a power supply, e.g. a battery.

In accordance with an example, the power supply is external to the device. In each of mentioned memory, the word «register» used in the specification may correspond to area of small capacity (some bits) or to very large area (e.g. a whole program or large amount of received or decoded data). The ROM 33 comprises at least a program and parameters. The ROM 33 may store algorithms and instructions to perform techniques in accordance with present principles. When switched on, the CPU 32 uploads the program in the RAM and executes the corresponding instructions.

The RAM 34 comprises, in a register, the program executed by the CPU 32 and uploaded after switch-on of the device 30, input data in a register, intermediate data in different states of the method in a register, and other variables used for the execution of the method in a register.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

In accordance with examples, the device 30 is configured to implement a method described in relation with FIG. 7, and belongs to a set comprising:
a mobile device;
a communication device;
a game device;
a tablet (or tablet computer);
a laptop;
a video camera;
an encoding chip;
a server (e.g. a broadcast server, a video-on-demand server or a web server).

FIG. 4 shows an example of an embodiment of the syntax of a stream when the data are transmitted over a packet-based transmission protocol. FIG. 4 shows an example structure 4 of a volumetric video stream. The structure consists in a container which organizes the stream in independent elements of syntax. The structure may comprise a header part 41 which is a set of data common to every syntax elements of the stream. For example, the header part comprises some of metadata about syntax elements, describing the nature and the role of each of them. The header part may also comprise a part of metadata of the adaptable and/or adapted atlases of FIG. 2, for instance the coordinates of a central point of view used for projecting points of a 3D scene as depicted in FIGS. 9 and 10. The structure comprises a payload comprising an element of syntax 42 and at least one element of syntax 43. Syntax element 42 comprises data representative of the color and depth frames. Images may have been compressed according to a video compression method.

Element of syntax 43 is a part of the payload of the data stream and may comprise metadata about how frames of element of syntax 42 are encoded, for instance parameters used for projecting and packing points of a 3D scene onto frames. Such metadata may be associated with each frame of the video or to group of frames (also known as Group of Pictures (GoP) in video compression standards). According to the present principles, metadata of element of syntax 43 also comprise at least one validity domain associated with at least one patch of the atlas. A validity domain is an information representative of a part of said viewing zone of the 3D space of the 3D scene and may be encoded according to different representations and structures. Examples of such representations and structures are provided in the present disclosure.

FIG. 7 illustrates a method 70 for converting a full-resolution 360° sectorized atlas sequence into a user-based atlas sequence. At a step 71, a sectorized volumetric content encoded as a sequence of atlas images is obtained. Each atlas image comprises patch pictures organized according to a sectorization of the three-dimensional space built around a center of projection/de-projection. Patches are packed in the atlas image according to a layout depending on this sectorization as depicted in relation to FIGS. 8 to 10. At a step 72, a request is received from a renderer. This renderer may be a remote process like a client device or a module process running on the same device as method 70. The request comprises information representative of a pose and of a period of rendering time. The pose corresponds to a location within the 3D de-projection (i.e. rendering) space and an orientation within this space. The pose is obtained from the pose of a virtual camera located in the rendering space and determining which part of the volumetric scene has to be rendered at a given time. The pose indicated in the request may be a prediction of a future pose of the camera. The period of rendering time corresponds to the temporal part of the video the device or the module sending the request associates with the predicted pose. It may correspond to the next Group of Picture to render when playing back the volumetric video content. At a step 73, sectors of the sectorization associated with the volumetric content are selected. They are selected to ensure that rendering information (i.e. patch pictures) necessary to render the volumetric video from a pose around the pose provided in the request and for the provided period of time belongs to the atlas sequence to transmit to the source of the request. At a step 74, the part of the volumetric content corresponding to the selected sector for the period of rendering time of the request is rearranged according to one of the embodiments described according to the present principles. Then, this part of the obtained volumetric content is transmitted to the source as a user-based volumetric content.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, Smartphones, tablets, computers, mobile phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

What is claimed:

1. A device comprising a memory associated with a processor configured to:
obtain patch pictures, a patch picture being a projection of a part of a 3D scene, wherein a patch is associated with a sector of a sectorization dividing a three-dimensional space in sectors;
receive a request comprising a pose information;
select sectors of the sectorization, the selected sectors comprising information for rendering the 3D scene based on the pose information; and
generate a data stream comprising patch pictures associated with the selected sectors.

2. The device of claim 1, wherein said processor is configured to:
pack the patch pictures associated with the selected sectors in an adapted atlas image; and
encode the adapted atlas image in the data stream.

3. The device of claim 2, wherein the processor is configured to slice-copy to the adapted atlas image, the patch pictures associated with the selected sectors from a source atlas image comprising patch pictures for each sector of the sectorization.

4. The device of claim 1, wherein said processor is configured to:
extract patch pictures from a source atlas image comprising patch pictures for each sector of the sectorization, the extracted patch pictures being associated with the selected sectors;
pack extracted patch pictures in an adapted atlas image; and
encode the adapted atlas image in the data stream.

5. The device of claim 1, wherein patch pictures associated with different selected sectors are packed in different adapted atlas images, each adapted atlas image being encoded in a different track of the data stream.

6. The device of claim 1, wherein the data stream is encoded in a lossless format.

7. The device of claim 1, wherein the request further comprises an indication of computing resources of a client device.

8. A method comprising:
obtaining patch pictures, a patch picture being a projection of a part of a 3D scene, wherein a patch is associated with a sector of a sectorization dividing a three-dimensional space in sectors;
receiving a request comprising a pose information;
selecting sectors of the sectorization, the selected sectors comprising information for rendering the 3D scene based on the pose information; and
generating a data stream comprising patch pictures associated with the selected sectors.

9. The method of claim 8, comprising:
packing the patch pictures associated with the selected sectors in an adapted atlas image; and
encoding the adapted atlas image in the data stream.

10. The method of claim 9, comprising slice-copying to the adapted atlas image, the patch pictures associated with the selected sectors from a source atlas image comprising patch pictures for each sector of the sectorization.

11. The method of claim 8, comprising:
extracting patch pictures from a source atlas image comprising patch pictures for each sector of the sectorization, the extracted patch pictures being associated with the selected sectors;
packing extracted patch pictures in an adapted atlas image; and
encoding the adapted atlas image in the data stream.

12. The method of claim 8, wherein patch pictures associated with different selected sectors are packed in different adapted atlas images, each adapted atlas image being encoded in a different track of the data stream.

13. The method of claim 8, wherein the data stream is encoded in a lossless format.

14. A device comprising a memory associated with a processor configured to:
send a request comprising a pose information;
receive a data stream encoding patch pictures, a patch picture being a projection of a part of a 3D scene, wherein a patch is associated with a sector of a sectorization dividing a three-dimensional space in sectors, the encoded patch pictures being associated with sectors of the sectorization selected for comprising information for rendering the 3D scene based on the pose information; and
rendering a viewport image for a viewpoint corresponding to the pose information by inverse projecting pixels of the patch pictures.

15. The device of claim 14, wherein the request further comprises an indication of computing resources of the device.

16. A method comprising:
sending a request comprising a pose information;
receiving a data stream encoding patch pictures, a patch picture being a projection of a part of a 3D scene, wherein a patch is associated with a sector of a sectorization dividing a three-dimensional space in sectors, the encoded patch pictures being associated with sectors of the sectorization selected for comprising information for rendering the 3D scene based on the pose information; and
rendering a viewport image for a viewpoint corresponding to the pose information by inverse projecting pixels of the patch pictures.

17. The method of claim 16, wherein the request further comprises an indication of computing resources of a device.

18. A non-transitory computer readable medium having stored thereon instructions for causing one or more processors to perform a method comprising:
sending a request comprising a pose information;
receiving a data stream encoding patch pictures, a patch picture being a projection of a part of a 3D scene, wherein a patch is associated with a sector of a sectorization dividing a three-dimensional space in sectors, the encoded patch pictures being associated with sectors of the sectorization selected for comprising information for rendering the 3D scene based on a pose information; and
rendering a viewport image for a viewpoint corresponding to the pose information by inverse projecting pixels of the patch pictures.
